(19) United States
(12) Patent Application Publication
(10) Pub. No.: US 2024/0259836 A1
(43) Pub. Date: Aug. 1, 2024

(54) SYSTEM AND METHOD FOR OPTIMIZING RADIO FREQUENCY CHANNEL RECONFIGURATION IN A TELECOMMUNICATIONS NETWORK

(71) Applicant: Rakuten Mobile, Inc., Tokyo (JP)

(72) Inventors: Pankaj SHETE, Tokyo (JP); Awn MUHAMMAD, Tokyo (JP)

(73) Assignee: Rakuten Mobile, Inc., Tokyo (JP)

(21) Appl. No.: 18/018,399

(22) PCT Filed: Dec. 29, 2022
(86) PCT No.: PCT/US2022/054222

§ 371 Date: Jan. 27, 2023

Related U.S. Application Data
(60) Provisional application No. 63/410,349, filed on Sep. 27, 2022.

(51) Int. Cl. H04W 24/02; H04L 41/16; H04W 72/04

(52) U.S. Cl. CPC H04W 24/02; H04L 41/16; H04W 72/04

(57) ABSTRACT

System and method for implementing an optimization of an RF reconfiguration within an O-RAN by a SMO framework, the method includes: collecting O1-related data providing O1 configurations required to perform the RF channel reconfiguration from an E2 node, wherein the O1-related data are collected between the E2 node and an open radio unit (O-RU); based on the collected O1-related data re-training of an AI/ML model, deploying and activating one re-trained AI/ML model for inferring data providing O1 configurations required to perform the RF channel reconfiguration within the O-RAN; monitoring the O1-related data providing O1 configurations required to perform the RF channel reconfiguration; evaluating the O1-related data providing O1 configurations required to perform the RF channel reconfiguration; determining to generate O1 configuration data to prepare and execute the RF channel reconfiguration and sending to the E2 node; implementing the RF channel reconfiguration within the O-RAN.

### TECHNICAL FIELD

Systems and methods consistent with the example embodiments of the present disclosure relate to creating and deployment of an optimization of a radio frequency (RF) channel reconfiguration in m-MIMO antennas to save energy in a telecommunications network.

### BACKGROUND

A radio access network (RAN) is an important component in a telecommunications system, as it connects end-user devices (or user equipment) to other parts of the network. The RAN includes a combination of various network elements (NEs) that connect the end-user devices to a core network. Traditionally, hardware and/or software of a particular RAN is vendor specific.

Open RAN (O-RAN) technology has emerged to enable multiple vendors to provide hardware and/or software to a telecommunications system. To this end, O-RAN disaggregates the RAN functions into an open centralized unit (O-CU), an open distributed unit (O-DU), and an open radio unit (O-RU). The O-CU is a logical node for hosting Radio Resource Control (RRC), Service Data Adaptation Protocol (SDAP), and/or Packet Data Convergence Protocol (PDCP) sublayers of the RAN. The O-DU is a logical node hosting Radio Link Control (RLC), Media Access Control (MAC), and Physical (PHY) sublayers of the O-RAN. The O-RU is a physical node that converts radio signals from antennas to digital signals that can be transmitted over the FrontHaul to an O-DU. Because these entities have open protocols and interfaces between them, they can be developed by different vendors.

In O-RANs according to the related art, massive multiple-input multiple-output (m-MIMO) antennas are used for beamforming techniques to increase cell capacity and traffic throughput. To realize beamforming, the RUs must concentrate power amplifiers at the antenna site by combining radiating elements such as Transmitter/Receiver (Tx/Rx) arrays.

In the related art, a maximum of 64 Transmitter/Receiver (Tx/Rx) arrays can be deployed to increase cell capacity and traffic throughput to a maximum, wherein the higher the number of Tx/Rx arrays the higher the more the cell capacity and the traffic throughput can be increased. In this case, m-MIMO antennas also consume maximum energy for beamforming.

The maximum of 64 Transmitter/Receiver (Tx/Rx) arrays is preferably used as the standard setting of m-MIMO antennas in the related. This maximum beamforming has the disadvantage that in case of low O-RAN loads, i.e., when the expected traffic volume or number of connected users is lower than the configured threshold, the high-power consumption of the RUs due to the maximum use of Tx/Rx arrays causes an energy ineffective operation of the RUs within the O-RAN.

### SUMMARY

According to embodiments, systems and methods are provided for implementing an optimization of a radio frequency (RF) channel reconfiguration in m-MIMO antennas of an O-RAN by an open radio access network by a service management and orchestration (SMO) comprising a non-real-time radio intelligent controller (NRT-RIC), an NRT-RIC framework, at least one SMO function and an rApp hosted by the NRT-RIC to generate, by the rApp, and implement, by one or more E2 nodes (i.e., O-RUs via the E nodes), O1 configuration data to prepare and execute the RF channel reconfiguration within the m-MIMO antennas, wherein assisted by artificial intelligence/machine learning (AI/ML) techniques, O1-related data from an E2-node (i.e., from the O-RU via the E2 nodes) are used for re-training, deploying and activating an AI/ML model for inferring data providing O1 configurations required to perform a RF channel reconfiguration within the m-MIMO antennas in the O-RU, and wherein the RF channel reconfiguration control provides O1 configurations required to perform RF channel reconfiguration in the O-RU considers the overall network energy efficiency instead of local optimization in the O-RAN. According to the example embodiments, the systems and methods allow for energy saving (ES) by reducing the power consumption of the O-RUs by RF channel reconfiguration (e.g., by switching off certain Transmitter/Receiver (Tx/Rx) arrays).

For example, in case of a low network load (i.e., when the expected traffic volume or number of connected users are lower than the configured threshold) ES can be achieved by reducing the power consumption of O-RUs by switching off, for example, 32 out of 64 Tx/Rx arrays of an O-RU in a digital m-MIMO architecture and thereby correspondingly reduce the number of spatial layers and Synchronization Signal Blocks (SSBs). The procedure (i.e., the involvement of respective O-RAN interfaces) of the RF Channel reconfiguration depends on the management architecture model (hybrid or hierarchical) and the deployment option.

The RF channel reconfiguration decision can be made by an AI/ML model within the inference host deployed at the NRT-RIC or at the near real-time radio intelligent controller (nRT-RIC). Among other parameters (i.e., prediction data) the AI/ML models may include prediction of future traffic, user mobility, and resource usage and may also predict expected energy efficiency enhancements, resource usage, and network performance for different ES optimization states.

As a result, the system and methods implement an NRT-RIC framework that allows a network operator to flexibly configure switch-off/on parameters for an RF channel reconfiguration (e.g., to switch off/on of Tx/Rx arrays within the m-MIMO antennas in the O-RU) in order to optimize overall network energy efficiency instead of local optimization in the O-RAN.

According to embodiments, a system for implementing an optimization of an radio frequency (RF) reconfiguration within an open radio access network (O-RAN) by a service management and orchestration (SMO) framework, the system includes a memory storing instructions; and at least one processor configured to implement a non-real-time radio intelligent controller (NRT-RIC), an NRT-RIC framework, at least one SMO function and an rApp hosted by the NRT-RIC, the at least one processor configured to execute the instructions to: collect, by an rApp, O1-related data providing O1 configurations required to perform the RF channel reconfiguration via an R1 interface through an NRT-RIC framework and via an O1 interface through a SMO function within the SMO framework from an E2 node, wherein the O1-related data are collected via an open front haul management plane (FH M-Plane) interface between the E2 node and an open radio unit (O-RU); based on the collected O1-related data, by the SMO, re-train at least one artificial intelligence/machine learning (AI/ML) model and, among the at least one re-trained AI/ML, deploy and activate, by the rApp, one re-trained AI/ML model for inferring data providing O1 configurations required to perform the RF channel reconfiguration within the O-RAN; monitor, by the rApp, via the R1 interface through the NRT-RIC framework and via an O1 interface through the SMO function within the SMO framework the O1-related data providing O1 configurations required to perform the RF channel reconfiguration; evaluate, by the rApp, the O1-related data providing O1 configurations required to perform the RF channel reconfiguration; determine, by the rApp, to generate O1 configuration data to prepare and execute the RF channel reconfiguration and send, by the rApp, via the R1 interface through the NRT-RIC framework and via the O1 interface through the at the least one SMO function within the SMO framework, the O1 configuration data to prepare and execute the RF channel reconfiguration to the least one E2 node; implement, by the E2 node and the O-RU, the RF channel reconfiguration within the O-RAN, wherein while implementing the at least one processor is further configured to: convert, by the E2 node, the O1 configuration data to prepare and execute the RF channel reconfiguration and instruct, by the E2 node, the O-RU to execute the RF channel reconfiguration via the open FH M-Plane.

The at least one processor, while re-training of at least one AI/ML model, may be further configured to: select, by the rApp, an AI/ML model from a plurality of AI/ML models; send, by the rApp, an initiation request for re-training the AI/ML model to the NRT-RIC framework; re-train the AI/ML model by the NRT-RIC framework; monitor, by the rApp, re-trained AI/ML model parameters and determining, based on the re-trained AI/ML model parameters, the retrieval of the re-trained AI/ML model from the NRT-RIC framework; request, by the rApp, the re-trained AI/ML model from the NRT-RIC framework; and sending, by the NRT-RIC framework, the re-trained AI/ML model to the rApp.

The at least one processor, while re-training of at least one AI/ML model, may be further configured to: re-train, by the rApp, an AI/ML model from the plurality of AI/ML models.

The O1-related data providing O1 configurations required to perform the RF channel reconfiguration may include at least one of configurations, performance indicators and measurement reports provided from the O-RU, wherein the measurement reports may include at least one of an energy efficiency/energy consumption EE/EC measurement report, and wherein the energy efficiency/energy consumption (EE/EC) measurement report may include at least one of Reference Signal Received Quality (RSRQ) measurement per Synchronization Signal Block (SSB) per cell, Reference Signals Received Power (RSRP) measurement per SSB per cell, Signal to Interference plus Noise Ratio (SINR) measurement per SSB per cell, energy consumption, power consumed by hardware component, transmit power, load statistics per cell and per carrier, such as number of active users, average number of Radio Resource Control (RRC) connections, average number of scheduled active users per Transmission Time Interval (TTI), Physical Resource Block (PRB) utilization, DownLink/UpLink (DL/UL) Cell/User throughput, Precoding Matrix Indicator/Channel State Information (PMI/CSI) reports, latency statistics per cell and power consumption metrics information on supported Tx/Rx array selections together with power consumption key performance indicators.

The at least one processor, while collecting the O1-related data providing O1 configurations required to perform the RF channel reconfiguration, may be configured to: send, by the rApp, an O1-related data collection request via an R1 interface through the NRT-RIC framework and via an O1 interface through the SMO function within the SMO framework to the E2-node; receive, by the E2 node, the O1-related data collection request from the SMO function and collect, by the E2 node, the O1-related data providing O1 configurations required to perform the RF channel reconfiguration from the O-RU via an open front haul management plane FH M-Plane interface between the E2 node and the open radio unit O-RU; and send, by the E2 node, the collected O1-related data providing O1 configurations required to perform the RF channel reconfiguration via the O1 interface through the SMO function and through the NRT-RIC framework within the SMO framework to the rApp via the R1 interface.

The O1 configuration data to prepare and execute the RF channel reconfiguration may include at least one of an O-RU Tx/Rx Array selection, a modification of the number of SU/MU MIMO spatial streams or data layers, a modification of the number of SSB beams and a modification of the O-RU antenna transmit power.

The at least one processor may be further configured to: monitor, by the NRT-RIC, the performance of the re-trained AI/ML model; determine that a predetermined performance objective is not achieved based on the collected O1-related data; and initiate a fallback mechanism and/or initiating an AI/ML model update or retraining.

According to embodiments, a method for implementing an optimization of an radio frequency (RF) reconfiguration within an open radio access network (O-RAN) by a service management and orchestration (SMO) framework, the method includes: collecting, by an rApp, O1-related data providing O1 configurations required to perform the RF channel reconfiguration via an R1 interface through an NRT-RIC framework and via an O1 interface through a SMO function within the SMO framework from an E2 node, wherein the O1-related data are collected via an open front haul management plane (FH M-Plane) interface between the E2 node and an open radio unit (O-RU); based on the collected O1-related data, by the SMO, re-training of at least one artificial intelligence/machine learning (AI/ML) model and, among the at least one re-trained AI/ML, deploying and activating, by the rApp, one re-trained AI/ML model for inferring data providing O1 configurations required to perform the RF channel reconfiguration within the O-RAN; monitoring, by the rApp, via the R1 interface through the NRT-RIC framework and via an O1 interface through the SMO function within the SMO framework the O1-related data providing O1 configurations required to perform the RF channel reconfiguration; evaluating, by the rApp, the O1-related data providing O1 configurations required to perform the RF channel reconfiguration; determining, by the rApp, to generate O1 configuration data to prepare and execute the RF channel reconfiguration and sending, by the rApp, via the R1 interface through the NRT-RIC framework and via the O1 interface through the at the least one SMO function within the SMO framework, the O1 configuration data to prepare and execute the RF channel reconfiguration to the least one E2 node; implementing, by the E2 node and the O-RU, the RF channel reconfiguration within the O-RAN, wherein the implementing includes: converting, by the E2 node, the O1 configuration data to prepare and execute and instructing, by the E2 node, the O-RU to execute the RF channel reconfiguration via the open FH M-Plane.

The re-training of at least one AI/ML model includes selecting, by the rApp, an AI/ML model from a plurality of AI/ML models; sending, by the rApp, an initiation request for re-training the AI/ML model to the NRT-RIC framework; re-training the AI/ML model by the NRT-RIC framework; monitoring, by the rApp, re-trained AI/ML model parameters and determining, based on the re-trained AI/ML model parameters, the retrieval of the re-trained AI/ML model from the NRT-RIC framework; requesting, by the rApp, the re-trained AI/ML model from the NRT-RIC framework; and sending, by the NRT-RIC framework, the re-trained AI/ML model to the rApp.

The re-training of at least one AI/ML model includes re-training, by the rApp, an AI/ML model from the plurality of AI/ML models.

The O1-related data providing O1 configurations required to perform the RF channel reconfiguration may include at least one of configurations, performance indicators and measurement reports provided from the O-RU, wherein the measurement reports may include at least one of an energy efficiency/energy consumption EE/EC measurement report, and wherein the energy efficiency/energy consumption (EE/EC) measurement report may include at least one of Reference Signal Received Quality (RSRQ) measurement per Synchronization Signal Block (SSB) per cell, Reference Signals Received Power (RSRP) measurement per SSB per cell, Signal to Interference plus Noise Ratio (SINR) measurement per SSB per cell, energy consumption, power consumed by hardware component, transmit power, load statistics per cell and per carrier, such as number of active users, average number of Radio Resource Control (RRC) connections, average number of scheduled active users per Transmission Time Interval (TTI), Physical Resource Block (PRB) utilization, DownLink/UpLink (DL/UL) Cell/User throughput, Precoding Matrix Indicator/Channel State Information (PMI/CSI) reports, latency statistics per cell and power consumption metrics information on supported Tx/Rx array selections together with power consumption key performance indicators.

The collecting the O1-related data providing O1 configurations required to perform the RF channel reconfiguration includes sending, by the rApp, an O1-related data collection request via an R1 interface through the NRT-RIC framework and via an O1 interface through the SMO function within the SMO framework to the E2-node; receiving, by the E2 node, the O1-related data collection request from the SMO function and collecting, by the E2 node, the O1-related data providing O1 configurations required to perform the RF channel reconfiguration from the O-RU via an open front haul management plane FH M-Plane interface between the E2 node and the open radio unit O-RU; and sending, by the E2 node, the collected O1-related data providing O1 configurations required to perform the RF channel reconfiguration via the O1 interface through the SMO function and through the NRT-RIC framework within the SMO framework to the rApp via the R1 interface.

The O1 configuration data to prepare and execute the RF channel reconfiguration may include at least one of an O-RU Tx/Rx Array selection, a modification of the number of SU/MU MIMO spatial streams or data layers, a modification of the number of SSB beams and a modification of the O-RU antenna transmit power.

The method may further include monitoring, by the NRT-RIC, the performance of the re-trained AI/ML model; determining that a predetermined performance objective is not achieved based on the collected O1-related data and initiating a fallback mechanism and/or initiating an AI/ML model update or retraining.

According to embodiments, a non-transitory computer-readable recording medium having recorded thereon instructions executable by at least one processor configured to implement a non-real-time radio intelligent controller (NRT-RIC), an NRT-RIC framework, at least one SMO function and an rApp hosted by the NRT-RIC, to perform a method for implementing an optimization of an radio frequency (RF) reconfiguration within an open radio access network (O-RAN) by a service management and orchestration (SMO) framework, the method includes: collecting, by an rApp, O1-related data providing O1 configurations required to perform the RF channel reconfiguration via an R1 interface through an NRT-RIC framework and via an O1 interface through a SMO function within the SMO framework from an E2 node, wherein the O1-related data are collected via an open front haul management plane (FH M-Plane) interface between the E2 node and an open radio unit (O-RU); based on the collected O1-related data, by the SMO, re-training of at least one artificial intelligence/machine learning (AI/ML) model and, among the at least one re-trained AI/ML, deploying and activating, by the rApp, one re-trained AI/ML model for inferring data providing O1 configurations required to perform the RF channel reconfiguration within the O-RAN; monitoring, by the rApp, via the R1 interface through the NRT-RIC framework and via an O1 interface through the SMO function within the SMO framework the O1-related data providing O1 configurations required to perform the RF channel reconfiguration; evaluating, by the rApp, the O1-related data providing O1 configurations required to perform the RF channel reconfiguration; determining, by the rApp, to generate O1 configuration data to prepare and execute the RF channel reconfiguration and sending, by the rApp, via the R1 interface through the NRT-RIC framework and via the O1 interface through the at the least one SMO function within the SMO framework, the O1 configuration data to prepare and execute the RF channel reconfiguration to the least one E2 node; implementing, by the E2 node and the O-RU, the RF channel reconfiguration within the O-RAN, wherein the implementing includes converting, by the E2 node, the O1 configuration data to prepare and execute and instructing, by the E2 node, the O-RU to execute the RF channel reconfiguration via the open FH M-Plane.

The re-training of at least one AI/ML model includes selecting, by the rApp, an AI/ML model from a plurality of AI/ML models; sending, by the rApp, an initiation request for re-training the AI/ML model to the NRT-RIC framework; re-training the AI/ML model by the NRT-RIC framework; monitoring, by the rApp, re-trained AI/ML model parameters and determining, based on the re-trained AI/ML model parameters, the retrieval of the re-trained AI/ML model from the NRT-RIC framework; requesting, by the rApp, the re-trained AI/ML model from the NRT-RIC framework; and sending, by the NRT-RIC framework, the re-trained AI/ML model to the rApp.

The re-training of at least one AI/ML model includes re-training, by the rApp, an AI/ML model from the plurality of AI/ML models.

The O1-related data providing O1 configurations required to perform the RF channel reconfiguration may include at least one of configurations, performance indicators and measurement reports provided from the O-RU, wherein the measurement reports may include at least one of an energy efficiency/energy consumption EE/EC measurement report, and wherein the energy efficiency/energy consumption (EE/EC) measurement report may include at least one of Reference Signal Received Quality (RSRQ) measurement per Synchronization Signal Block (SSB) per cell, Reference Signals Received Power (RSRP) measurement per SSB per cell, Signal to Interference plus Noise Ratio (SINR) measurement per SSB per cell, energy consumption, power consumed by hardware component, transmit power, load statistics per cell and per carrier, such as number of active users, average number of Radio Resource Control (RRC) connections, average number of scheduled active users per Transmission Time Interval (TTI), Physical Resource Block (PRB) utilization, DownLink/UpLink (DL/UL) Cell/User throughput, Precoding Matrix Indicator/Channel State Information (PMI/CSI) reports, latency statistics per cell and power consumption metrics information on supported Tx/Rx array selections together with power consumption key performance indicators.

The collecting the O1-related data providing O1 configurations required to perform the RF channel reconfiguration includes sending, by the rApp, an O1-related data collection request via an R1 interface through the NRT-RIC framework and via an O1 interface through the SMO function within the SMO framework to the E2-node; receiving, by the E2 node, the O1-related data collection request from the SMO function and collecting, by the E2 node, the O1-related data providing O1 configurations required to perform the RF channel reconfiguration from the O-RU via an open front haul management plane FH M-Plane interface between the E2 node and the open radio unit O-RU; and sending, by the E2 node, the collected O1-related data providing O1 configurations required to perform the RF channel reconfiguration via the O1 interface through the SMO function and through the NRT-RIC framework within the SMO framework to the rApp via the R1 interface.

The O1 configuration data to prepare and execute the RF channel reconfiguration may include at least one of an O-RU Tx/Rx Array selection, a modification of the number of SU/MU MIMO spatial streams or data layers, a modification of the number of SSB beams and a modification of the O-RU antenna transmit power.

The method may further include monitoring, by the NRT-RIC, the performance of the re-trained AI/ML model; determining that a predetermined performance objective is not achieved based on the collected O1-related data and initiating a fallback mechanism and/or initiating an AI/ML model update or retraining.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates an O-RAN architecture in the related art;

FIG. 2 is a diagram of an example environment in which systems and/or methods, described herein, may be implemented;

FIG. 3 is a diagram of example components of a device according to an embodiment;

FIG. 4 illustrates the NRT-RIC framework within an O-RAN according to an embodiment;

FIG. 5 is a flow diagram of a method for implementing an optimization of RF reconfiguration according to an embodiment;

FIG. 6 illustrates a data collection flow according to an embodiment;

FIG. 7 illustrates a data analysis, AI/ML model training and inference flow according to an embodiment; and

FIG. 8 illustrates a data analysis, AI/ML model training and inference flow according to another embodiment; and

FIG. 9 illustrates the generation and implementation of O1 configurations data to prepare and execute perform RF channel reconfiguration in m-MIMO antennas in O-RUs according to an embodiment.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide systems and methods in which an NRT-RIC framework and/or an rApp configures RF channel reconfiguration parameters (e.g., for switching off/on Tx/Rx arrays in m-MIMO antennas in O-RUs) that allow for a flexible RF channel reconfiguration by, for example, A1 policies or optimization triggers over O1 interface formulated by NRT-RIC (i.e., by the at least one rApp hosted by the NRT-RIC and/or the NRT-RIC framework assisted by machine learning (ML) techniques) towards the nRT-RIC, wherein the nRT-RIC via an E2 interface actions may enforce the deployment of the O1 configuration data to prepare and execute the RF channel reconfiguration towards one or more E2 nodes, wherein the implementation based on said O1 configuration data to prepare and execute the cell and RF channel reconfiguration in the O-RU is commenced by the E2 nodes via the open FH M-Plane interface between the E2 node and the O-RU.

To this end, before applying an RF channel reconfiguration (e.g., switching off/on Tx/Rx arrays), the E2 node may need to perform preparation actions for RF channel reconfiguration. For example, the E2 node may check load statistics per cell and per carrier, such as number of active users, average number of Radio Resource Control (RRC) connections, average number of scheduled active users per Transmission Time Interval (TTI), Physical Resource Block (PRB) utilization, DownLink/UpLink (DL/UL) Cell/User throughput, Precoding Matrix Indicator/Channel State Information (PMI/CSI) reports. Moreover, E2 node may check the latency statistics per cell (e.g., if the Ultra-Reliable Low Latency Communications (URLLC) slices are involved, latency is used for energy efficiency EE definition).

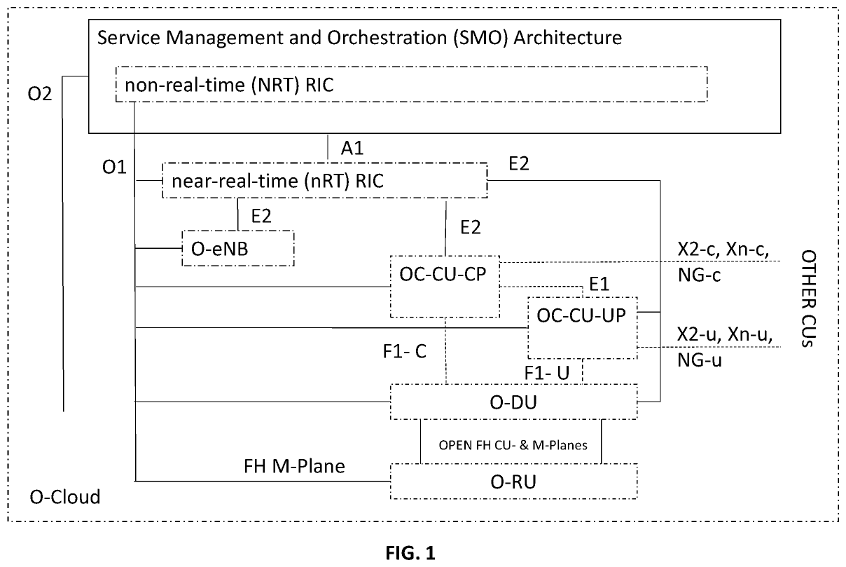

FIG. 1 illustrates a related art O-RAN architecture. Referring to FIG. 1, RAN functions in the O-RAN architecture are controlled and optimized by a RIC. The RIC is a software-defined component that implements modular applications to facilitate the multivendor operability required in the O-RAN system, as well as to automate and optimize RAN operations. The RIC is divided into two types: a non-real-time RIC (NRT-RIC) and a near-real-time RIC (nRT-RIC).

The NRT-RIC is the control point of a non-real-time control loop and operates on a timescale greater than 1 second within the Service Management and Orchestration (SMO) framework. Its functionalities are implemented through modular applications called rApps (rApp 1, . . . , rApp N), and include: providing policy based guidance and enrichment across the A1 interface, which is the interface that enables communication between the NRT-RIC and the nRT-RIC; performing data analytics; Artificial Intelligence/Machine Learning (AI/ML) training and inference for RAN optimization; and/or recommending configuration management actions over the O1 interface, which is the interface that connects the SMO to RAN managed elements (e.g., nRT-RIC, O-RAN Centralized Unit (O-CU), O-RAN Distributed Unit (O-DU), etc.).

The nRT-RIC operates on a timescale between 10 milliseconds and 1 second and connects to the O-DU, O-CU (disaggregated into the O-CU control plane (O-CU-CP) and the O-CU user plane (O-CU-UP)), and an open evolved NodeB (O-eNB) via the E2 interface. The nRT-RIC uses the E2 interface to control the underlying RAN elements (E2 nodes/network functions (NFs)) over a near-real-time control loop. The nRT-RIC monitors, suspends/stops, overrides, and controls the E2 nodes (O-CU, O-DU, and O-eNB) via policies. For example, the nRT-RIC sets policy parameters on activated functions of the E2 nodes. Further, the nRT-RIC hosts xApps to implement functions such as quality of service (QOS) optimization, mobility optimization, slicing optimization, interference mitigation, load balancing, security, etc. The two types of RICs work together to optimize the O-RAN. For example, the NRT-RIC provides, over the A1 interface, the policies, data, and artificial intelligence/machine learning AI/ML models enforced and used by the nRT-RIC for RAN optimization, and the nRT-RIC returns policy feedback (i.e., how the policy set by the NRT-RIC works).

The SMO framework, within which the NRT-RIC is located, manages and orchestrates RAN elements. Specifically, the SMO manages and orchestrates what is referred to as the O-Ran Cloud (O-Cloud). The O-Cloud is a collection of physical RAN nodes that host the RICs, O-CUs, and O-DUs, the supporting software components (e.g., the operating systems and runtime environments), and the SMO itself. In other words, the SMO manages the O-Cloud from within. The O2 interface is the interface between the SMO and the O-Cloud it resides in. Through the O2 interface, the SMO provides infrastructure management services (IMS) and deployment management services (DMS).

The O-Cloud, on the other hand, is a cloud computing platform comprising a collection of physical infrastructure nodes that meet O-RAN requirements to host the relevant O-RAN functions (e.g., nRT-RIC, O-CU-CP, O-CU-UP, O-DU, etc.), the supporting software components (such as Operating System, Virtual Machine Monitor, Container Runtime, etc.) and the appropriate management and orchestration functions.

The SMO framework, within which the NRT-RIC is located, manages and orchestrates RAN elements. The SMO performs management and orchestration of RAN elements through four key interfaces: the A1 Interface between the NRT-RIC in the SMO and the nRT-RIC for RAN Optimization; the O1 Interface between the SMO and the O-RAN Network Functions for FCAPS support; in the case of a hybrid model, an Open Fronthaul M-plane interface between SMO and O-RU for FCAPS support; the O2 Interface between the SMO and the O-Cloud to platform resources and workload management.

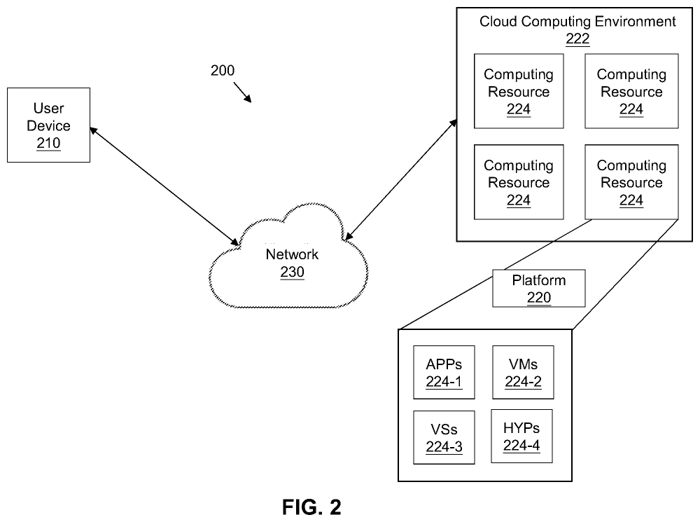

FIG. 2 is a diagram of an example environment 200 in which systems and/or methods, described herein, may be implemented. As shown in FIG. 2, environment 200 may include a user device 210, a platform 220, and a network 230. Devices of environment 200 may interconnect via wired connections, wireless connections, or a combination of wired and wireless connections. In embodiments, any of the functions and operations described with reference to FIG. 1 above may be performed by any combination of elements illustrated in FIG. 2.

User device 210 includes one or more devices capable of receiving, generating, storing, processing, and/or providing information associated with platform 220. For example, user device 210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 210 may receive information from and/or transmit information to platform 220.

Platform 220 includes one or more devices capable of receiving, generating, storing, processing, and/or providing information. In some implementations, platform 220 may include a cloud server or a group of cloud servers. In some implementations, platform 220 may be designed to be modular such that certain software components may be swapped in or out depending on a particular need. As such, platform 220 may be easily and/or quickly reconfigured for different uses.

In some implementations, as shown, platform 220 may be hosted in cloud computing environment 222. Notably, while implementations described herein describe platform 220 as being hosted in cloud computing environment 222, in some implementations, platform 220 may not be cloud-based (i.e., may be implemented outside of a cloud computing environment) or may be partially cloud-based.

Cloud computing environment 222 includes an environment that hosts platform 220. Cloud computing environment 222 may provide computation, software, data access, storage, etc., services that do not require end-user (e.g., user device 210) knowledge of a physical location and configuration of system(s) and/or device(s) that hosts platform 220. As shown, cloud computing environment 222 may include a group of computing resources 224 (referred to collectively as “computing resources 224” and individually as “computing resource 224”).

Computing resource 224 includes one or more personal computers, a cluster of computing devices, workstation computers, server devices, or other types of computation and/or communication devices. In some implementations, computing resource 224 may host platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, or the like.

Application 224-1 includes one or more software applications that may be provided to or accessed by user device 210. Application 224-1 may eliminate the need to install and execute the software applications on user device 210. For example, application 224-1 may include software associated with platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports the execution of a complete operating system (“OS”). A process virtual machine may execute a single program, and may support a single process. In some implementations, virtual machine 224-2 may execute on behalf of a user (e.g., user device 210), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

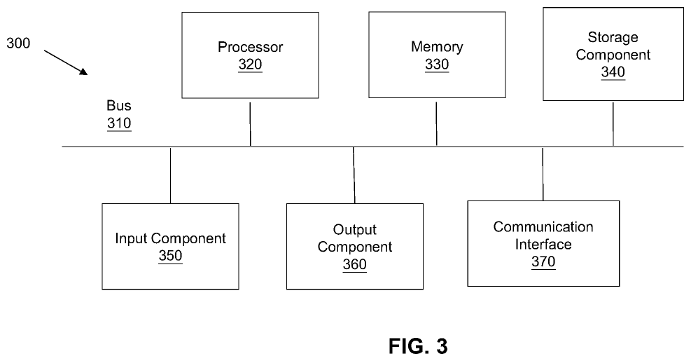

FIG. 3 is a diagram of example components of a device 300. Device 300 may correspond to user device 210 and/or platform 220. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 may be implemented in hardware, firmware, or a combination of hardware and software. Processor 320 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random-access memory (RAM), a read-only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive. Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

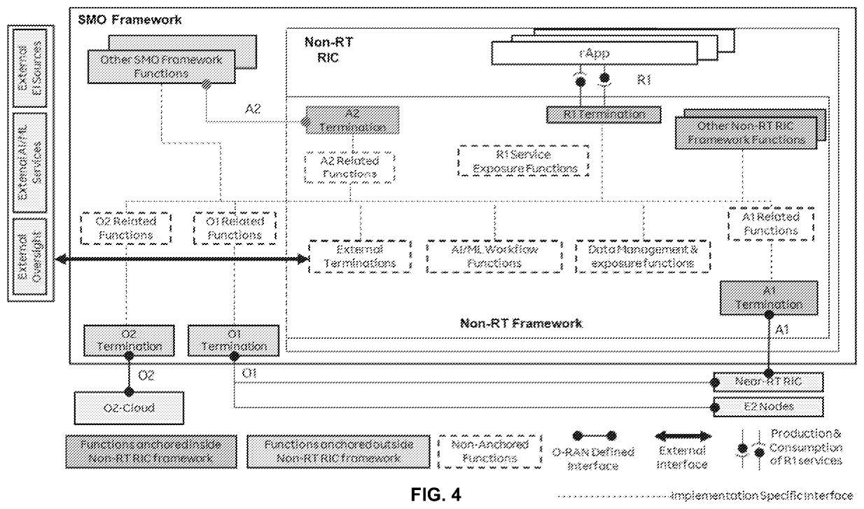

In embodiments, any one of the operations or processes of FIGS. 4, 5, 6, 7 and 8 may be implemented by or using any one of the elements illustrated in FIGS. 1, 2 and 3. It is understood that other embodiments are not limited thereto, and may be implemented in a variety of different architectures (e.g., bare metal architecture, any cloud-based architecture or deployment architecture such as Kubernetes, Docker, OpenStack, etc.).

FIG. 4 illustrates the NRT-RIC framework (or platform) and the rApp hosted by the NRT-RIC with regard to the R1 interface within the SMO framework system architecture and the O1, O2, A1 interface within an O-RAN according to an embodiment.

Referring to FIG. 4, the NRT-RIC represents a subset of functionalities of the SMO framework. The NRT-RIC can access other SMO framework functionalities and thereby influence (i.e., controls and/or executes) what is carried across the O1 and O2 interface (e.g., performing configuration management (CM) and/or performance management (PM)).

In general, the O1 interface between management entities (Network Management System NMS/Element Management System EMS/Management and Organization of Network Function Virtualization MANO) and O-RAN managed elements, for operation and management, by which FCAPS management, software management, file management shall be achieved.

SMO framework system architecture includes SMO functions that include an O1 termination that enables the communication between the SMO framework and E2 nodes (i.e., O-CU, O-DU, etc.) via the O1 interface.

The NRT-RIC includes an NRT-RIC framework. The NRT-RIC framework, among a plurality of other functions, includes R1 service exposure functions that handle R1 services provided in accordance with example embodiments. In general, the NRT-RIC functions within the NRT-RIC framework support the authorization, authentication, registration, discovery, communication support, etc., for the rAPPs.

In general, R1 services may include a collection of services including, but not limited to, service registration and discovery services, authentication and authorization services, AI/ML workflow services, and A1, O1 and O2-interface-related services.

NRT-RIC Applications (rApps) are applications that leverage the functionalities available in the NRT-RIC framework and/or SMO Framework to provide value-added services related to RAN operation and optimization. The scope of rApps includes, but is not limited to, radio resource management, data analytics, etc., and enrichment of information. In general, an rApp refers to an application designed to consume and/or produce R1 services.

To this end, the NRT-RIC framework produces and/or consumes R1 services according to example embodiments via an R1 interface. The R1 interface terminates in an R1 termination of the NRT-RIC framework. The R1 termination connects to the NRT-RIC framework and the rApps via the R1 interface and enables the NRT-RIC framework and rApps to exchange messages/data (i.e., requests and responses comprising of data models) to access the R1 services via the R1 interface.

In general, the R1 interface is defined as an interface between rApps and the NRT-RIC framework via which R1 services can be produced and consumed.

Moreover, the NRT-RIC framework comprises A1-related functions. The A1-related functions of the NRT-RIC framework support, for example, A1 logical termination, A1-policy coordination and catalog, A1-E1 coordination and catalog, etc.

The data management and exposure services within the NRT-RIC framework deliver data created or collected by data producers to data consumers according to their needs (e.g., function management (FM)/consumption management (CM)/production management (PM) data to rApps or CM changes from rApps to the O-RAN via the O1 interface.

The NRT-RIC framework further comprises External Terminations. The External Terminations, for example, support an exchange of data between the NRT-RIC framework and external AI/ML functions, Enrichment Information (E1) Sources, or an External Oversight.

Within the NRT-RIC framework, the AI/ML workflow services provide access to AI/ML workflow. For example, the AI/ML workflow services may assist in training models, monitoring, etc. the deployed AI/ML models in NRT-RIC.

Moreover, the NRT-RIC framework comprises A2-related functions that support, for example, A2 logical termination, A2-Policy coordination and catalog, etc.

Still referring to FIG. 4, within the NRT-RIC, the R1 interface is an open logical interface within the O-RAN architecture between the rApps and the NRT-RIC framework of the NRT-RIC. The R1 interface supports the exchange of control signaling information and data collection and delivery between endpoints. The R1 interface enables, for example, multi-vendor rApps to consume and/or produce the R1 services.

The R1 interface is independent of specific implementations of the SMO and NRT-RIC framework of the NRT-RIC. The R1 interface is defined in an extensible way that enables new services and data types to be added without needing to change the protocols or the procedures.

In particular, the R1 interface facilitates the interconnection between rApps and the NRT-RIC framework supplied by different vendors (i.e., facilitates interconnection in a multi-vendor environment). To this end, the R1 interface provides a level of abstraction between the rApps and NRT-RIC Framework and/or SMO Framework.

Referring to FIG. 4, the NRT-RIC framework (e.g., the at least one rApp hosted by the NRT-RIC and/or the NRT-RIC framework) allows for a flexible RF channel reconfiguration (e.g., for switching off/on Tx/Rx arrays in m-MIMO antennas in O-RUs), for example, A1 policies or optimization triggers over O1 interface formulated by NRT-RIC (i.e., by the at least one rApp hosted by the NRT-RIC and/or the NRT-RIC framework assisted by machine learning (ML) techniques) towards nRT-RIC, wherein the nRT-RIC via E2 interface actions may enforce the deployment of RF channel reconfiguration parameters towards the one more E2 nodes.

Referring to FIG. 4., the SMO framework function is configured to collect configurations, performance indicators and measurement reports (e.g., cell load-related information and traffic information, energy efficiency EE measurement reports, energy consumption EC measurement reports, etc.) from the E2 nodes and the O-RUs (via the E2 nodes) for the purpose of decision making. The decision making may be based on, for example, using training and inference of AI/ML models that assist such energy efficiency EE and/or energy consumption EC functions.

In general, Energy Efficiency EE is defined as the relation between the useful output and energy/power consumption, and Energy Consumption EC is defined as an integral of power consumption over time.

Moreover, the SMO framework function is configured to transfer collected data towards the NRT-RIC framework and to signal (i.e., send) updated RF Channel reconfiguration parameters and the execution of optimization actions to the E2 Node via the O1 interface.

The NRT-RIC framework is configured to collect configurations, performance indicators and measurement reports (e.g., cell load-related information and traffic information, energy efficiency EE measurement reports and/or energy consumption EC measurement reports, etc.) for the purpose of decision-making. The decision-making may be based on, for example, using training and inference of AI/ML models that assist such energy efficiency EE and/or energy saving ES functions.

Moreover, the NRT-RIC framework is configured to transfer collected data (i.e., O1-related data for RF channel reconfiguration parameters (e.g., for switching off/on Tx/Rx arrays in m-MIMO antennas in O-RUs) towards the rApp and to signal (i.e., send) updated configurations for EE/ES optimization towards E2 Nodes (i.e., O-CU, O-DU, etc.) through the SMO framework function.

In an example embodiment, the NRT-RIC framework may be configured to retrain, update, configure EE/ES AI/ML models in NRT-RIC.

Still referring to FIG. 4, the one or more rApps hosted by the NRT-RIC are configured (e.g., may comprise R1/O1 consumer and/or production services) to retrieve the necessary configurations, performance indicators, and measurement reports, etc., from the E2 nodes and O-RUs (via the E2 nodes forwarded by the SMO), for the purpose of training and execution of relevant AI/ML models (e.g., EE/ES AI/ML models).

Moreover, the one or more rApps hosted by the NRT-RIC are configured (e.g., may comprise R1/O1 consumer and/or production services) to infer an optimized O1 configuration for EE/ES through R1/O1 interface.

In an example embodiment, the rApps may be configured to retrain, update, and configure EE/ES AI/ML models.

To this end, the one or more E2 nodes (i.e., O-DUs, O-CUs, etc.) of FIG. 1 are configured to report, for example, cell configuration, performance indicators, measurement reports (e.g., cell load-related information, traffic information, EE/EC measurement reports, etc.), etc. to the SMO via the O1 interface. SMO framework functions such as the O1 termination enable the SMO to communicate with the E2 nodes.

Moreover, the one or more E2 nodes (i.e., O-DUs, O-CUs, etc.) of FIG. 1 are configured to perform RF Channel reconfiguration (e.g., O-RU Tx/Rx array selection, modification of the number of SSB beams, modification of the O-RU antenna transmit power, modification of the number of single-user/multiple-user (SU/MU) MIMO data layers or spatial streams) as part of EE/ES optimization.

In an example embodiment, the O-RUs of FIG. 1 are configured to report energy consumption EC and energy efficiency EE-related information (e.g., cell load-related information, traffic information, EE/EC measurement reports, etc.) via an open FH M-Plane interface to the E2-node (i.e., the O-DU).

In an example embodiment, the one or more O-RUs of FIG. 1 may be configured to report energy consumption EC and energy efficiency EE-related information (e.g., cell load-related information, traffic information, EE/EC measurement reports, etc.) to the SMO/NRT-RIC directly.

Herewithinbelow, the decision making, potentially including AI/ML model training and inference, is done at the NRT-RIC

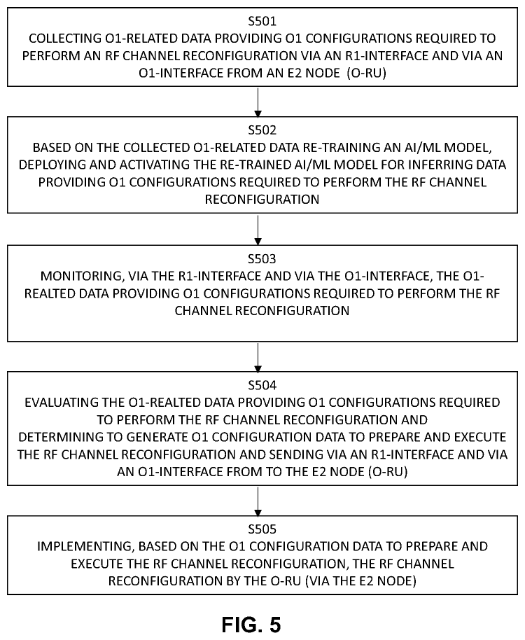

FIG. 5 is a flow diagram of a method for implementing an optimization of an RF channel reconfiguration in m-MIMO antennas in O-Rus according to an embodiment.

Referring to FIG. 5, the method for optimizing an RF channel reconfiguration in m-MIMO antennas in O-RUs is implemented by a service management and orchestration (SMO) framework comprising a non-real-time radio intelligent controller (NRT-RIC), an NRT-RIC framework, at least one SMO function (e.g., an O1 termination) and an rApp hosted by the NRT-RIC. The SMO framework may function as a mediator between the rApps and the E2 nodes and the O-RUs (via the E2 nodes) within the O-RAN.

In step 501, the rApp collects O1-related data providing O1 configurations required to perform the RF channel reconfiguration via an R1 interface through an NRT-RIC framework and via an O1 interface through an SMO function within the SMO framework (i.e., an SMO function configured as an O1 termination of the O1 interface at the SMO) from an E2 node (i.e., an O-CU, an O-DU, etc.), wherein the O1-related data are collected via an open front haul management plane (FH M-Plane) interface between the E2 node and an open radio unit (O-RU).

In an example embodiment, the collecting of the O1-related data providing O1 configurations required to perform the RF channel reconfiguration may include sending, by the rApp, an O1-related data collection request via an R1 interface through the NRT-RIC framework and via an O1 interface through the SMO function within the SMO framework (i.e., the O1 termination) to the E2-node. The E2 node may receive the O1-related data collection request from the SMO function and collects the O1-related data providing O1 configurations required to perform the RF channel reconfiguration from the O-RU via an open front haul management plane FH M-Plane interface between the E2 node and the open radio unit O-RU.

In an example embodiment, with regard to the collection of O1-related data providing O1 configurations required to perform the RF channel reconfiguration, the E2 node may activate a measure report (i.e., a EE/EC measurement report) towards an O-RU and the O-RU provides measurement data (i.e. input data) for the measurement report.

Upon collecting the O1-related data from the O-RU, the E2 node may send the collected O1-related data providing O1 configurations required to perform the RF channel reconfiguration via the O1 interface through the SMO function and through the NRT-RIC framework within the SMO framework to the rApp via the R1 interface.

In step 502, based on the collected O1-related data, the SMO re-trains at least one artificial intelligence/machine learning (AI/ML) model and, among the at least one re-trained AI/ML, deploys and activates, by the rApp, one re-trained AI/ML model for inferring data providing O1 configurations required to perform the RF channel reconfiguration within the O-RAN.

In an example embodiment, the O1-related data providing O1 configurations required to perform the RF channel reconfiguration may be input data, for example, measurement data, used in the AI/ML model training and inference.

The O1-related data (i.e. the input data) providing O1 configurations required to perform the RF channel reconfiguration, among other O1-related data, may include the following measurement data to monitor energy consumption & energy efficiency EC/EE of one or more E2 Nodes and one or more O-RUs: Down Link Packet Data Convergence Protocol Service Data Unit DL PDCP SDU Data Volume per interface (Data Volume in DL delivered from O-CU-UP to O-DU, per public land mobile network PLMN, per quality of service QoS level, per slice, per F1-U interface, Xn-U interface, X2-U interface, Up Link Packet Data Convergence Protocol Service Data Unit UP PDCP SDU Data Volume per interface (Data Volume in UL delivered from O-CU-UP to O-DU, per public land mobile network PLMN, per quality of service QoS level, per slice, per F1-U interface, Xn-U interface, X2-U interface, Reference Signal Received Quality RSRQ measurement per Synchronization Signal Block SSB per cell, Reference Signals Received Power RSRP measurement per SSB per cell, Signal to Interference plus Noise Ratio SINR measurement per SSB per cell, energy consumption, power consumed by hardware component, transmit power, load statistics per cell and per carrier, such as number of active users, average number of Radio Resource Control (RRC) connections, average number of scheduled active users per Transmission Time Interval (TTI), Physical Resource Block (PRB) utilization, DownLink/UpLink (DL/UL) Cell/User throughput, Precoding Matrix Indicator/Channel State Information (PMI/CSI) reports, latency statistics per cell (e.g., if the Ultra-Reliable Low Latency Communications (URLLC) slices are involved, latency is used for energy efficiency EE definition), power consumption metrics (i.e., mean total/per carrier power consumption, mean total/per carrier transmit power) information on supported Tx/Rx array selections together with power consumption (i.e., site/O-RU input power needed for certain EE key performance indicators (KPIs)), etc.

In an example, embodiment, the NRT-RIC framework may re-train at least one AI/ML model. According to this example embodiment, the rApp selects an AI/ML model from a plurality of AI/ML models and sends an initiation request for re-training the AI/ML model to the NRT-RIC framework. The NRT-RIC framework re-trains the AI/ML model. Meanwhile, the rApp monitors re-trained AI/ML model parameters and determines, based on the re-trained AI/ML model parameters, the retrieval of the re-trained AI/ML model from the NRT-RIC framework. Based on the determination to retrieval, the rApp requests the re-trained AI/ML model from the NRT-RIC framework. Upon receiving the request, the NRT-RIC framework sends the re-trained AI/ML model to the rApp.

In another example embodiment, rApp hosts the plurality of AI/ML models and re-trains one AI/ML model of the plurality of AI/ML models.

Still referring to FIG. 5, in step 503, the rApp monitors the O1-related data providing O1 configurations required to perform the RF channel reconfiguration via the R1 interface through the NRT-RIC framework and via an O1 interface through the SMO function within the SMO framework.

In an example embodiment, the rApp may be constantly monitoring, for example, performance and energy consumption of the E2 Node and energy consumption of the O-RU.

Moreover, in an example embodiment, the rApp monitors performance and energy consumption parameters for evaluation of necessary O1 configurations required to perform the RF channel reconfiguration. These performance and energy consumption parameters may include configurations, performance indicators, measurement reports (e.g., cell load-related information, traffic information, EE/EC measurement reports, etc.).

For example, the O1-related data providing O1 configurations required to perform the RF channel reconfiguration (i.e., input data) may include at least one of configurations, performance indicators and measurement reports provided from the O-RU, wherein the measurement reports may include at least one of a cell load related information. measurement report, traffic information measurement report, energy efficiency/energy consumption EE/EC measurement report, and wherein the energy efficiency/energy consumption EE/EC measurement report may include at least one of the energy consumption of the E2 Node and energy consumption of the O-RU and one or more performance-related key performance indicators of the E2 node.

In step 504, the rApp evaluates the O1-related data providing O1 configurations required to perform the RF channel reconfiguration and determines to generate O1 configuration data to prepare and execute the RF channel reconfiguration.

Moreover, in step 504, upon generating the O1 configuration data to prepare and execute the RF channel reconfiguration, the rApp sends, via the R1 interface through the NRT-RIC framework and via the O1 interface through the SMO function, the O1 configuration data to prepare and execute the RF channel reconfiguration to the E2 node.

In an example embodiment, based on the O1-related data providing O1 configurations required to perform the RF channel reconfiguration (i.e., input data), the rApp determines to generate O1 configuration data to prepare and execute the RF channel reconfiguration (i.e., output data) in case a predetermined performance objective (e.g., an EE/ES performance objective) is not achieved. In this case, the rApp generates O1 configuration data to prepare and execute the RF channel reconfiguration.

For example, the EE/ES performance objective may be a A1 policy in the NRT-RIC or may be based on targets set by a network operator for energy saving ES functions in the NRT-RIC (i.e., predetermined performance parameters for EE/ES within the O-RAN, for example, one or more predetermined performance objectives for EE/EC within the O-RAN).

In an example embodiment, the generated O1 configuration data to prepare and execute the RF channel reconfiguration (i.e., output data) may include, for example, NRCellCU Information Object Class IOC, NRCellDU IOC, GNBDUFunction IOC, GNBCUCPFunction IOC, GNBCUUPFunction IOC, etc. as, for example, defined in 3GPP TS 28.541: “3rd Generation Partnership Project; Technical Specification Group Services and System Aspects; Management and orchestration; 5G Network Resource Model (NRM); Stage 2 and stage 3”, Release 16, December 2020 to enable an energy saving RF channel reconfiguration.

For example, the RF channel reconfiguration may include an O-RU Tx/Rx Array selection, a modification of the number of SU/MU MIMO spatial streams or data layers, a modification of the number of SSB beams, a modification of the O-RU antenna transmit power, etc.

In step 505, upon receiving the O1 configuration data to prepare and execute the RF channel reconfiguration at the E2 node, the E2 node converts the O1 configuration data to prepare and execute the RF channel reconfiguration and instructs the O-RU to execute the RF channel reconfiguration via the open FH M-Plane.

In an example embodiment, the implementation of the O1 configuration data to prepare and execute the RF channel reconfiguration further may include that the O-RU notifies the E2 node about the completion of the implementation of the RF channel reconfiguration.

The E2 node, upon receiving the notification from the O-RU, notifies the rApp via an O1 interface through the SMO function and via an R1 interface through the NRT-RIC framework. According to the example embodiment, the O-RU may notify the E2 node via an open front haul management plane FH M-Plane interface between the E2 node and the O-RU.

In a further example embodiment, after the implementation in step 505, the NRT-RIC may monitor the performance of the re-trained AI/ML model and determine that the predetermined performance objective is not achieved. In this case, the NRT-RIC may initiate a fallback mechanism and/or initiate the AI/ML model to be updated or to be retrained.

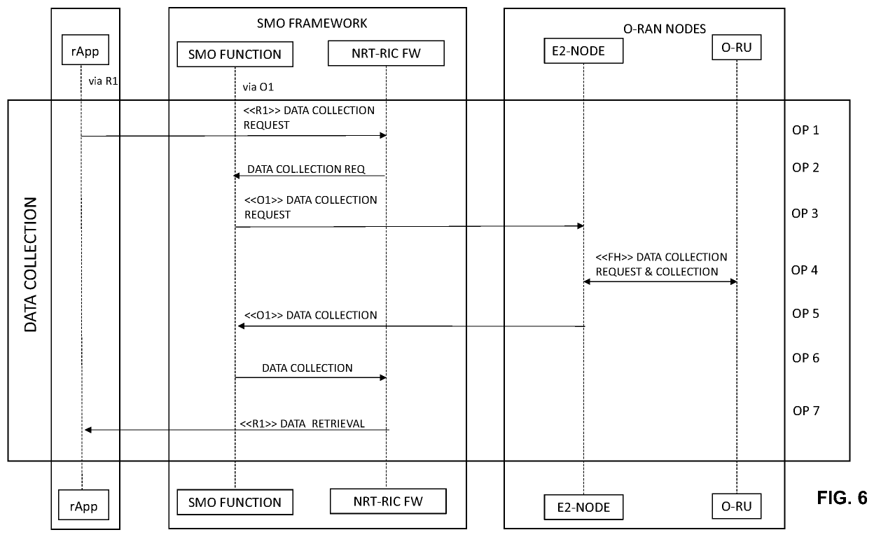

FIG. 6 illustrates a data collection flow according to an embodiment. Referring to FIG. 6, the data collection aims for enabling an RF channel by means of RF channel reconfiguration parameter change (i.e., implementation of O1 configuration data to prepare and execute the RF channel reconfiguration) and actions controlled by NRT-RIC that allow for an AI/ML-based solution to optimize the RF channel for EE/ES within the O-RAN.

To this end, the SMO function may be an O1 termination point for the O1 interface. The Non-RT-RIC Framework and/or the rApp may carry out the RF channel reconfiguration AI/ML-based optimization. The E2 nodes and the O-RU of the at least one O-RAN may enforce (i.e., implement) optimization configurations for RF channel reconfiguration.

Referring to FIG. 6, once when R1 interface and O1 interface connectivity and the open FH M-Plane interface are established between the E2 node and O-RU. The communication path between the rApp and the E2 nodes and the O-RU within the O-RAN is established.

In accordance with the O-RAN system architecture, the NRT-RIC has knowledge about overlapping carriers/cells and the coverage of those carriers/cells (e.g., which carrier/cell is a coverage layer, and which is a capacity layer).

In order to optimize the EE/ES with the O-RAN, a network operator may set the targets (i.e., predetermined performance parameters for EE/ES within the O-RAN, for example, one or more predetermined performance objectives for EE/EC within the O-RAN) for energy saving ES functions in the NRT-RIC. The target may include comprise ES targets that reduce the power consumption of O-RUs by switching off, for example, 56, 48, 32, 16, 8, etc. out of 64 Tx/Rx arrays of an O-RU in a digital m-MIMO architecture and thereby correspondingly reduce the number of spatial layers and Synchronization Signal Blocks (SSBs).

As a result, the method for optimizing the RF channel reconfiguration may start when a network operator enables the optimization rApp along with an initial AI/ML model for RF channel reconfiguration ES functions and the E2 Node and the O-RU become operational.

In operation 1, the rApp requests to collect O1-related data such as necessary configurations, performance indicators, measurement data (i.e., the input data) towards NRT-RIC framework via the R1 interface.

In operation 2, the NRT-RIC framework requests the SMO framework to collect O1-related data (i.e., the input data) from E2 Nodes.

In operation 3, the SMO framework function (i.e., SMO function) requests the data collection towards E2 nodes and to the O-RU (via the E2 nodes).

In operation 4, the one or more E2 nodes (i.e., the O-CU, O-DU, etc.), upon receiving the request from SMO, request and collect O1-related data (i.e., the input data) from O-RU via the open FH M-Plane interface.

In operation 5, the one or more E2 nodes (i.e., the O-CU, O-DU, etc.) send the O1-related data (i.e., the input data) to the SMO periodically and/or event-based.

In operation 6, the NRT-RIC retrieves the O1-related (i.e., the input data) (e.g., for consuming and/or producing R1 services related to EE/ES).

In operation 7, the rApp retrieves the O1-related data (i.e., the input data) for processing (e.g., for consuming and/or producing R1 services related to EE/ES).

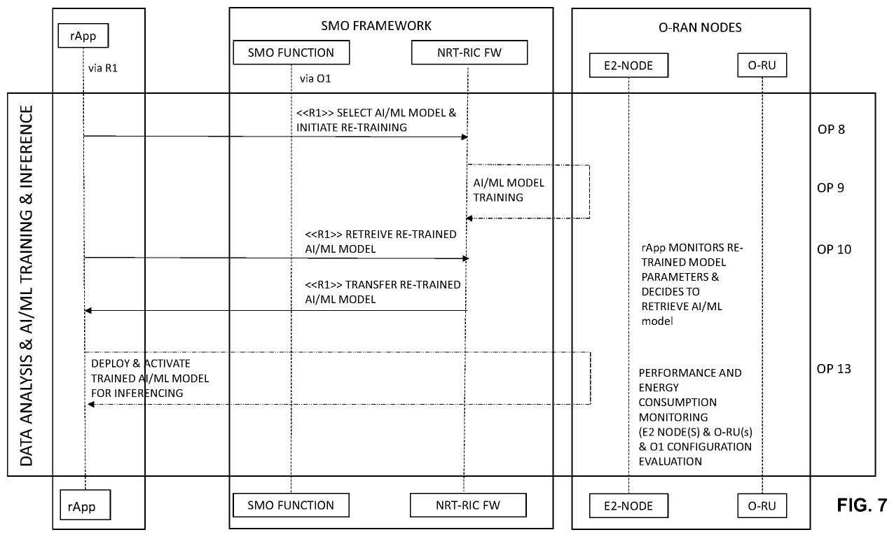

FIG. 7 illustrates data analysis, AI/ML model training and inference flow according to an embodiment. Referring to FIG. 7, in operation 8, at least one AI/ML model, from a plurality of AI/ML models, can be retrained either on the NRT-RIC framework or on rApp. In an example embodiment, in case the NRT-RIC framework is hosting the retraining of the at least one AI/ML model, among the plurality of AI/ML models, the rApp selects an AI/ML Model among the plurality of AI/ML models and initiates retraining of the selected AI/ML Model on Non-RT-RIC framework. In an example embodiment, the AI/ML model retraining and selection may be performed by alternative AI/ML workflow within the SMO.

In operation 9, upon receiving a retraining request from the rApp, the NRT-RIC framework initiates AI/ML model retraining.

In operation 10, the rApp monitors the retrained AIML model and retrieves retrained AI/ML Model from the NRT-RIC. In an example embodiment, the AI/ML model retrieval procedure over R1 interface may be performed by an alternative AI/ML workflow within the SMO based on R1 services.

In operation 11, upon receiving a retrieval request from the rApp, the NRT-RIC framework transfers AI/ML model (i.e., the retrained AI/ML model) to the rApp.

In an example embodiment, the AI/ML model transfer procedure over the R1 interface may be performed by an alternative AI/ML workflow within the SMO based on R1 services.

In operation 12, in case the AI/ML model retraining is hosted by rApp, the AI/ML model is retrained on rApp itself.

In operation 13, once the AI/ML model retraining is performed, the at least one AI/ML model (including the retrained AI/ML model) is deployed and activated for inferencing (i.e., for inferring data providing O1 configurations required to perform the RF channel reconfiguration within the O-RAN).

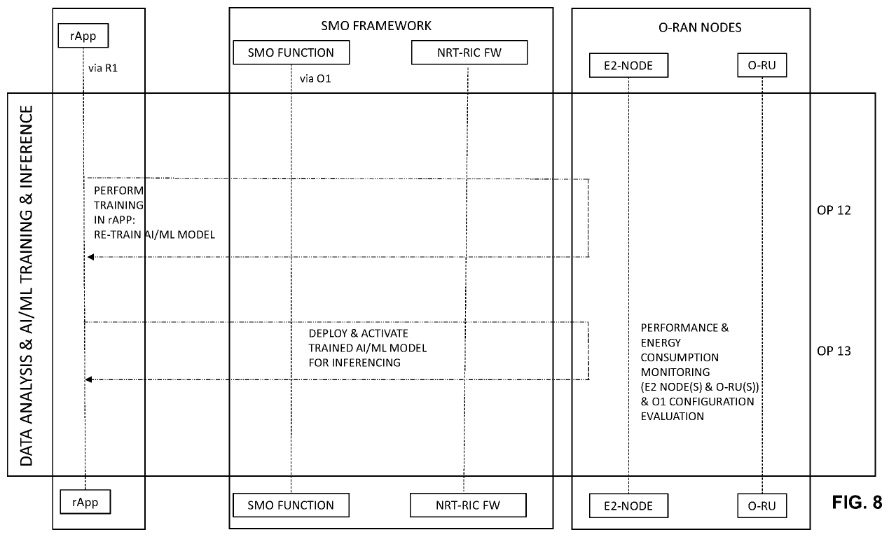

FIG. 8 illustrates a data analysis, AI/ML model training and inference flow according to an embodiment. Referring to FIG. 8, data analysis, AI/ML training and inference may be performed by the rApp.

To this end, in operation 12, the AI/ML model retraining is hosted by rAp and the AI/ML model is retrained on rApp itself.

In operation 13 of FIG. 8, once the AI/ML model retraining is performed, the at least one AI/ML model (including the retrained AI/ML model) are deployed and activated for inferencing (i.e., for inferring data providing O1 configurations required to perform a cell and/or carrier switch off/on within the O-RAN).

Referring to FIG. 7 and FIG. 8, in operation 13, the rApp constantly monitors the performance and energy consumption of the E2 Node(s), the energy consumption of O-RU(s), etc. For example, the rApp monitors performance & energy consumption for evaluation of necessary O1 configurations (i.e., the input data) required to perform the RF channel reconfiguration.

In an example embodiment, the O1-related data (i.e., the input data) may be input data used in the AI/ML model training and inference. The O1-related data, among other O1-related data, may include the following measurement data to monitor energy consumption & energy efficiency EC/EE of one or more E2 Nodes and one or more O-RUs: Down Link Packet Data Convergence Protocol Service Data Unit DL PDCP SDU Data Volume per interface (Data Volume in DL delivered from O-CU-UP to O-DU, per public land mobile network PLMN, per quality of service QoS level, per slice, per F1-U interface, Xn-U interface, X2-U interface, Up Link Packet Data Convergence Protocol Service Data Unit UP PDCP SDU Data Volume per interface (Data Volume in UL delivered from O-CU-UP to O-DU, per public land mobile network PLMN, per quality of service QoS level, per slice, per F1-U interface, Xn-U interface, X2-U interface, Reference Signal Received Quality RSRQ measurement per Synchronization Signal Block SSB per cell, Reference Signals Received Power RSRP measurement per SSB per cell, Signal to Interference plus Noise Ratio SINR measurement per SSB per cell, energy consumption, power consumed by hardware component, transmit power, load statistics per cell and per carrier, such as number of active users, average number of Radio Resource Control (RRC) connections, average number of scheduled active users per Transmission Time Interval (TTI), Physical Resource Block (PRB) utilization, DownLink/UpLink (DL/UL) Cell/User throughput, Precoding Matrix Indicator/Channel State Information (PMI/CSI) reports, latency statistics per cell (e.g., if the Ultra-Reliable Low Latency Communications (URLLC) slices are involved, latency is used for energy efficiency EE definition), power consumption metrics (i.e., mean total/per carrier power consumption, mean total/per carrier transmit power) information on supported Tx/Rx array selections together with power consumption (i.e., site/O-RU input power needed for certain EE key performance indicators (KPIs)), etc.

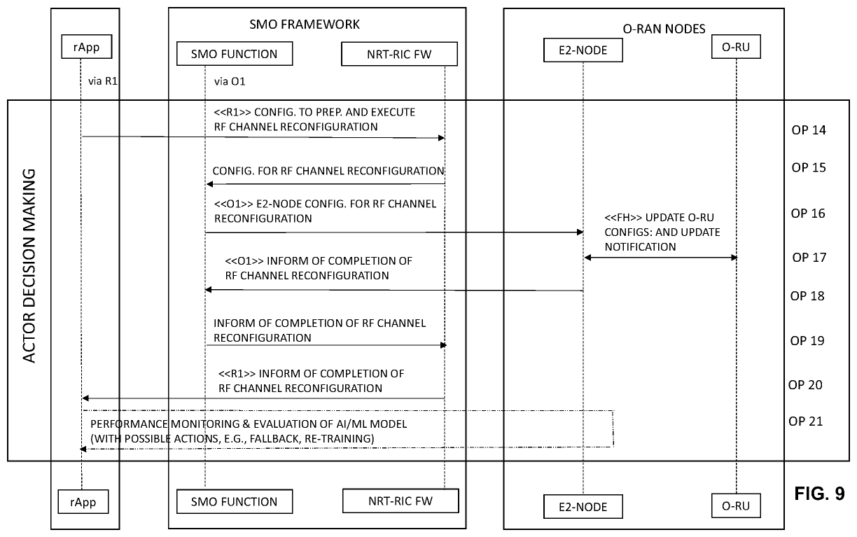

FIG. 9 illustrates the generation and implementation of O1 configurations to prepare and execute the RF channel reconfiguration according to an embodiment.

Referring to FIG. 9, in operation 14, the rApp generates O1 configurations to prepare and execute for RF channel reconfiguration (i.e., the output data) and sends the O1 configurations (i.e., the output data) via the R1 interface towards SMO through NRT-RIC Framework.

In an example embodiment, the generated O1 configuration data to prepare and execute the RF Channel reconfiguration (i.e., the output data) may include output data such as, for example, NRCellCU Information Object Class IOC, NRCellDU IOC, GNBDUFunction IOC, GNBCUCPFunction IOC, GNBCUUPFunction IOC, etc. as, for example, defined in 3GPP TS 28.541: “3rd Generation Partnership Project; Technical Specification Group Services and System Aspects; Management and orchestration; 5G Network Resource Model (NRM); Stage 2 and stage 3”, Release 16, December 2020 to enable Energy saving cell & carrier shutdown and to re-configure the resources via O1 interface.

Moreover, the O1 configuration data to prepare and execute the RF Channel reconfiguration (i.e., the output data) may include output data, such as, an O-RU Tx/Rx Array selection, a modification of the number of SU/MU MIMO spatial streams or data layers, a modification of the number of SSB beams, a modification of the O-RU antenna transmit power, etc.

In operation 15, the NRT-RIC requests the SMO framework function (i.e., the SMO function) to configure the E2 Node to prepare and execute the RF channel reconfiguration through the O1 interface.

In operation 16, the SMO instructs the E2 node, via the O1 interface, to perform the received request(s) from the rApp.

In operation 17, the E2 Node informs the O-RU about the updated O-RU configuration (i.e., the RF channel reconfiguration) via the open FH M-Plane. In an example embodiment, the O-RU may notify the E2 Node once the O-RU completed the RF channel reconfiguration implementation

In operation 18, the E2 Node notifies the SMO once the RF channel reconfiguration implementation is completed.

In operation 19, the SMO framework function (i.e., the SMO function) notifies the NRT-RIC framework about the completion of the RF channel reconfiguration.

In operation 20, the NRT-RIC notifies the rApp about the completion of the RF channel reconfiguration over R1 interface.

In operation 21, the NRT-RIC continuously analyses performance of AI/ML model. In an example embodiment, in case the energy saving objectives are not achieved, the NRT-RIC may decide to initiate fallback mechanism, and/or updates or retrains the AI/ML model.

In an example embodiment, the method for optimizing a RF channel reconfiguration may end when an E2 Node becomes non-operational or when the operator disables the optimization functions or the AI/ML model for energy saving (i.e., AI/ML model for EE/ES).

In another example embodiment, the rApp continues close-loop monitoring of the Energy-Saving function at the E2 node and the O-RU (via the E2 node).

According to operation 21, the E2 Node(s) and the O-RU(s) operate using the newly deployed parameters (i.e., O1 configuration data)/models (i.e., retrained AI/ML model) and state (i.e., off/on state of RF channel reconfiguration).

According to embodiments, a system for implementing an optimization of an radio frequency (RF) reconfiguration within an open radio access network (O-RAN) by a service management and orchestration (SMO) framework, the system includes a memory storing instructions; and at least one processor configured to implement a non-real-time radio intelligent controller (NRT-RIC), an NRT-RIC framework, at least one SMO function and an rApp hosted by the NRT-RIC, the at least one processor configured to execute the instructions to: collect, by an rApp, O1-related data providing O1 configurations required to perform the RF channel reconfiguration via an R1 interface through an NRT-RIC framework and via an O1 interface through a SMO function within the SMO framework from an E2 node, wherein the O1-related data are collected via an open front haul management plane (FH M-Plane) interface between the E2 node and an open radio unit (O-RU); based on the collected O1-related data, by the SMO, re-train at least one artificial intelligence/machine learning (AI/ML) model and, among the at least one re-trained AI/ML, deploy and activate, by the rApp, one re-trained AI/ML model for inferring data providing O1 configurations required to perform the RF channel reconfiguration within the O-RAN; monitor, by the rApp, via the R1 interface through the NRT-RIC framework and via an O1 interface through the SMO function within the SMO framework the O1-related data providing O1 configurations required to perform the RF channel reconfiguration; evaluate, by the rApp, the O1-related data providing O1 configurations required to perform the RF channel reconfiguration; determine, by the rApp, to generate O1 configuration data to prepare and execute the RF channel reconfiguration and send, by the rApp, via the R1 interface through the NRT-RIC framework and via the O1 interface through the at the least one SMO function within the SMO framework, the O1 configuration data to prepare and execute the RF channel reconfiguration to the least one E2 node; implement, by the E2 node and the O-RU, the RF channel reconfiguration within the O-RAN, wherein while implementing the at least one processor is further configured to: convert, by the E2 node, the O1 configuration data to prepare and execute the RF channel reconfiguration and instruct, by the E2 node, the O-RU to execute the RF channel reconfiguration via the open FH M-Plane.

The at least one processor, while re-training of at least one AI/ML model, may be further configured to: select, by the rApp, an AI/ML model from a plurality of AI/ML models; send, by the rApp, an initiation request for re-training the AI/ML model to the NRT-RIC framework; re-train the AI/ML model by the NRT-RIC framework; monitor, by the rApp, re-trained AI/ML model parameters and determining, based on the re-trained AI/ML model parameters, the retrieval of the re-trained AI/ML model from the NRT-RIC framework; request, by the rApp, the re-trained AI/ML model from the NRT-RIC framework; and sending, by the NRT-RIC framework, the re-trained AI/ML model to the rApp.

The at least one processor, while re-training of at least one AI/ML model, may be further configured to: re-train, by the rApp, an AI/ML model from the plurality of AI/ML models.

The O1-related data providing O1 configurations required to perform the RF channel reconfiguration may include at least one of configurations, performance indicators and measurement reports provided from the O-RU, wherein the measurement reports may include at least one of an energy efficiency/energy consumption EE/EC measurement report, and wherein the energy efficiency/energy consumption (EE/EC) measurement report may include at least one of Reference Signal Received Quality (RSRQ) measurement per Synchronization Signal Block (SSB) per cell, Reference Signals Received Power (RSRP) measurement per SSB per cell, Signal to Interference plus Noise Ratio (SINR) measurement per SSB per cell, energy consumption, power consumed by hardware component, transmit power, load statistics per cell and per carrier, such as number of active users, average number of Radio Resource Control (RRC) connections, average number of scheduled active users per Transmission Time Interval (TTI), Physical Resource Block (PRB) utilization, DownLink/UpLink (DL/UL) Cell/User throughput, Precoding Matrix Indicator/Channel State Information (PMI/CSI) reports, latency statistics per cell and power consumption metrics information on supported Tx/Rx array selections together with power consumption key performance indicators.

The at least one processor, while collecting the O1-related data providing O1 configurations required to perform the RF channel reconfiguration, may be configured to: send, by the rApp, an O1-related data collection request via an R1 interface through the NRT-RIC framework and via an O1 interface through the SMO function within the SMO framework to the E2-node; receive, by the E2 node, the O1-related data collection request from the SMO function and collect, by the E2 node, the O1-related data providing O1 configurations required to perform the RF channel reconfiguration from the O-RU via an open front haul management plane FH M-Plane interface between the E2 node and the open radio unit O-RU; and send, by the E2 node, the collected O1-related data providing O1 configurations required to perform the RF channel reconfiguration via the O1 interface through the SMO function and through the NRT-RIC framework within the SMO framework to the rApp via the R1 interface.

The O1 configuration data to prepare and execute the RF channel reconfiguration may include at least one of an O-RU Tx/Rx Array selection, a modification of the number of SU/MU MIMO spatial streams or data layers, a modification of the number of SSB beams and a modification of the O-RU antenna transmit power.

The at least one processor may be further configured to: monitor, by the NRT-RIC, the performance of the re-trained AI/ML model; determine that a predetermined performance objective is not achieved based on the collected O1-related data; and initiate a fallback mechanism and/or initiating an AI/ML model update or retraining.

According to embodiments, a method for implementing an optimization of an radio frequency (RF) reconfiguration within an open radio access network (O-RAN) by a service management and orchestration (SMO) framework, the method includes: collecting, by an rApp, O1-related data providing O1 configurations required to perform the RF channel reconfiguration via an R1 interface through an NRT-RIC framework and via an O1 interface through a SMO function within the SMO framework from an E2 node, wherein the O1-related data are collected via an open front haul management plane (FH M-Plane) interface between the E2 node and an open radio unit (O-RU); based on the collected O1-related data, by the SMO, re-training of at least one artificial intelligence/machine learning (AI/ML) model and, among the at least one re-trained AI/ML, deploying and activating, by the rApp, one re-trained AI/ML model for inferring data providing O1 configurations required to perform the RF channel reconfiguration within the O-RAN; monitoring, by the rApp, via the R1 interface through the NRT-RIC framework and via an O1 interface through the SMO function within the SMO framework the O1-related data providing O1 configurations required to perform the RF channel reconfiguration; evaluating, by the rApp, the O1-related data providing O1 configurations required to perform the RF channel reconfiguration; determining, by the rApp, to generate O1 configuration data to prepare and execute the RF channel reconfiguration and sending, by the rApp, via the R1 interface through the NRT-RIC framework and via the O1 interface through the at the least one SMO function within the SMO framework, the O1 configuration data to prepare and execute the RF channel reconfiguration to the least one E2 node; implementing, by the E2 node and the O-RU, the RF channel reconfiguration within the O-RAN, wherein the implementing includes: converting, by the E2 node, the O1 configuration data to prepare and execute and instructing, by the E2 node, the O-RU to execute the RF channel reconfiguration via the open FH M-Plane.

The re-training of at least one AI/ML model includes selecting, by the rApp, an AI/ML model from a plurality of AI/ML models; sending, by the rApp, an initiation request for re-training the AI/ML model to the NRT-RIC framework; re-training the AIML model by the NRT-RIC framework; monitoring, by the rApp, re-trained AI/ML model parameters and determining, based on the re-trained AI/ML model parameters, the retrieval of the re-trained AI/ML model from the NRT-RIC framework; requesting, by the rApp, the re-trained AI/ML model from the NRT-RIC framework; and sending, by the NRT-RIC framework, the re-trained AIML model to the rApp.

The re-training of at least one AI/ML model includes re-training, by the rApp, an AI/ML model from the plurality of AI/ML models.

The O1-related data providing O1 configurations required to perform the RF channel reconfiguration may include at least one of configurations, performance indicators and measurement reports provided from the O-RU, wherein the measurement reports may include at least one of an energy efficiency/energy consumption EE/EC measurement report, and wherein the energy efficiency/energy consumption (EE/EC) measurement report may include at least one of Reference Signal Received Quality (RSRQ) measurement per Synchronization Signal Block (SSB) per cell, Reference Signals Received Power (RSRP) measurement per SSB per cell, Signal to Interference plus Noise Ratio (SINR) measurement per SSB per cell, energy consumption, power consumed by hardware component, transmit power, load statistics per cell and per carrier, such as number of active users, average number of Radio Resource Control (RRC) connections, average number of scheduled active users per Transmission Time Interval (TTI), Physical Resource Block (PRB) utilization, DownLink/UpLink (DL/UL) Cell/User throughput, Precoding Matrix Indicator/Channel State Information (PMI/CSI) reports, latency statistics per cell and power consumption metrics information on supported Tx/Rx array selections together with power consumption key performance indicators.

The collecting the O1-related data providing O1 configurations required to perform the RF channel reconfiguration includes sending, by the rApp, an O1-related data collection request via an R1 interface through the NRT-RIC framework and via an O1 interface through the SMO function within the SMO framework to the E2-node; receiving, by the E2 node, the O1-related data collection request from the SMO function and collecting, by the E2 node, the O1-related data providing O1 configurations required to perform the RF channel reconfiguration from the O-RU via an open front haul management plane FH M-Plane interface between the E2 node and the open radio unit O-RU; and sending, by the E2 node, the collected O1-related data providing O1 configurations required to perform the RF channel reconfiguration via the O1 interface through the SMO function and through the NRT-RIC framework within the SMO framework to the rApp via the R1 interface.

The O1 configuration data to prepare and execute the RF channel reconfiguration may include at least one of an O-RU Tx/Rx Array selection, a modification of the number of SU/MU MIMO spatial streams or data layers, a modification of the number of SSB beams and a modification of the O-RU antenna transmit power.

The method may further include monitoring, by the NRT-RIC, the performance of the re-trained AI/ML model; determining that a predetermined performance objective is not achieved based on the collected O1-related data and initiating a fallback mechanism and/or initiating an AI/ML model update or retraining.

According to embodiments, a non-transitory computer-readable recording medium having recorded thereon instructions executable by at least one processor configured to implement a non-real-time radio intelligent controller (NRT-RIC), an NRT-RIC framework, at least one SMO function and an rApp hosted by the NRT-RIC, to perform a method for implementing an optimization of an radio frequency (RF) reconfiguration within an open radio access network (O-RAN) by a service management and orchestration (SMO) framework, the method includes: collecting, by an rApp, O1-related data providing O1 configurations required to perform the RF channel reconfiguration via an R1 interface through an NRT-RIC framework and via an O1 interface through a SMO function within the SMO framework from an E2 node, wherein the O1-related data are collected via an open front haul management plane (FH M-Plane) interface between the E2 node and an open radio unit (O-RU); based on the collected O1-related data, by the SMO, re-training of at least one artificial intelligence/machine learning (AI/ML) model and, among the at least one re-trained AI/ML, deploying and activating, by the rApp, one re-trained AI/ML model for inferring data providing O1 configurations required to perform the RF channel reconfiguration within the O-RAN; monitoring, by the rApp, via the R1 interface through the NRT-RIC framework and via an O1 interface through the SMO function within the SMO framework the O1-related data providing O1 configurations required to perform the RF channel reconfiguration; evaluating, by the rApp, the O1-related data providing O1 configurations required to perform the RF channel reconfiguration; determining, by the rApp, to generate O1 configuration data to prepare and execute the RF channel reconfiguration and sending, by the rApp, via the R1 interface through the NRT-RIC framework and via the O1 interface through the at the least one SMO function within the SMO framework, the O1 configuration data to prepare and execute the RF channel reconfiguration to the least one E2 node; implementing, by the E2 node and the O-RU, the RF channel reconfiguration within the O-RAN, wherein the implementing includes converting, by the E2 node, the O1 configuration data to prepare and execute and instructing, by the E2 node, the O-RU to execute the RF channel reconfiguration via the open FH M-Plane.

The re-training of at least one AI/ML model includes selecting, by the rApp, an AI/ML model from a plurality of AI/ML models; sending, by the rApp, an initiation request for re-training the AI/ML model to the NRT-RIC framework; re-training the AI/ML model by the NRT-RIC framework; monitoring, by the rApp, re-trained AI/ML model parameters and determining, based on the re-trained AI/ML model parameters, the retrieval of the re-trained AI/ML model from the NRT-RIC framework; requesting, by the rApp, the re-trained AI/ML model from the NRT-RIC framework; and sending, by the NRT-RIC framework, the re-trained AIML model to the rApp.

The re-training of at least one AI/ML model includes re-training, by the rApp, an AI/ML model from the plurality of AI/ML models.

The O1-related data providing O1 configurations required to perform the RF channel reconfiguration may include at least one of configurations, performance indicators and measurement reports provided from the O-RU, wherein the measurement reports may include at least one of an energy efficiency/energy consumption EE/EC measurement report, and wherein the energy efficiency/energy consumption (EE/EC) measurement report may include at least one of Reference Signal Received Quality (RSRQ) measurement per Synchronization Signal Block (SSB) per cell, Reference Signals Received Power (RSRP) measurement per SSB per cell, Signal to Interference plus Noise Ratio (SINR) measurement per SSB per cell, energy consumption, power consumed by hardware component, transmit power, load statistics per cell and per carrier, such as number of active users, average number of Radio Resource Control (RRC) connections, average number of scheduled active users per Transmission Time Interval (TTI), Physical Resource Block (PRB) utilization, DownLink/UpLink (DL/UL) Cell/User throughput, Precoding Matrix Indicator/Channel State Information (PMI/CSI) reports, latency statistics per cell and power consumption metrics information on supported Tx/Rx array selections together with power consumption key performance indicators.

The collecting the O1-related data providing O1 configurations required to perform the RF channel reconfiguration includes sending, by the rApp, an O1-related data collection request via an R1 interface through the NRT-RIC framework and via an O1 interface through the SMO function within the SMO framework to the E2-node; receiving, by the E2 node, the O1-related data collection request from the SMO function and collecting, by the E2 node, the O1-related data providing O1 configurations required to perform the RF channel reconfiguration from the O-RU via an open front haul management plane FH M-Plane interface between the E2 node and the open radio unit O-RU; and sending, by the E2 node, the collected O1-related data providing O1 configurations required to perform the RF channel reconfiguration via the O1 interface through the SMO function and through the NRT-RIC framework within the SMO framework to the rApp via the R1 interface.

The O1 configuration data to prepare and execute the RF channel reconfiguration may include at least one of an O-RU Tx/Rx Array selection, a modification of the number of SU/MU MIMO spatial streams or data layers, a modification of the number of SSB beams and a modification of the O-RU antenna transmit power.

The method may further include monitoring, by the NRT-RIC, the performance of the re-trained AI/ML model; determining that a predetermined performance objective is not achieved based on the collected O1-related data and initiating a fallback mechanism and/or initiating an AI/ML model update or retraining.

According to the example embodiments, the systems and methods allow for energy saving (ES) by reducing the power consumption of the O-RUs by RF channel reconfiguration (e.g., by switching off certain Transmitter/Receiver (Tx/Rx) arrays). The ES can be achieved by reducing the power consumption of O-RUs by switching off, for example, 32 out of 64 Tx/Rx arrays of an O-RU in a digital m-MIMO architecture and thereby correspondingly reduce the number of spatial layers and Synchronization Signal Blocks (SSBs).

As a result, the systems and methods implement an NRT-RIC framework that allows a network operator to flexibly configure an RF channel reconfiguration (e.g., to switch off/on of Tx/Rx arrays within the m-MIMO antennas in the O-RU) in order to optimize overall network energy efficiency instead of local optimization in the O-RAN.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A system for implementing an optimization of an radio frequency (RF) reconfiguration within an open radio access network (O-RAN) by a service management and orchestration (SMO) framework, the system comprising:
a memory storing instructions; and
at least one processor configured to implement a non-real-time radio intelligent controller (NRT-RIC), an NRT-RIC framework, at least one SMO function and an rApp hosted by the NRT-RIC, the at least one processor configured to execute the instructions to:
collect, by an rApp, O1-related data providing O1 configurations required to perform the RF channel reconfiguration via an R1 interface through an NRT-RIC framework and via an O1 interface through a SMO function within the SMO framework from an E2 node, wherein the O1-related data are collected via an open front haul management plane (FH M-Plane) interface between the E2 node and an open radio unit (O-RU);
based on the collected O1-related data, by the SMO, re-train at least one artificial intelligence/machine learning (AI/ML) model and,
among the at least one re-trained AI/ML, deploy and activate, by the rApp, one re-trained AI/ML model for inferring data providing O1 configurations required to perform the RF channel reconfiguration within the O-RAN;
monitor, by the rApp, via the R1 interface through the NRT-RIC framework and via an O1 interface through the SMO function within the SMO framework the O1-related data providing O1 configurations required to perform the RF channel reconfiguration;
evaluate, by the rApp, the O1-related data providing O1 configurations required to perform the RF channel reconfiguration;
determine, by the rApp, to generate O1 configuration data to prepare and execute the RF channel reconfiguration and
send, by the rApp, via the R1 interface through the NRT-RIC framework and via the O1 interface through the at the least one SMO function within the SMO framework, the O1 configuration data to prepare and execute the RF channel reconfiguration to the least one E2 node;
implement, by the E2 node and the O-RU, the RF channel reconfiguration within the O-RAN, wherein while implementing the at least one processor is further configured to:
convert, by the E2 node, the O1 configuration data to prepare and execute the RF channel reconfiguration and
instruct, by the E2 node, the O-RU to execute the RF channel reconfiguration via the open FH M-Plane.

2. The system as claimed in claim 1, wherein while re-training of at least one AI/ML model the at least one processor is further configured to:
select, by the rApp, an AI/ML model from a plurality of AI/ML models;
send, by the rApp, an initiation request for re-training the AI/ML model to the NRT-RIC framework;
re-train the AI/ML model by the NRT-RIC framework;
monitor, by the rApp, re-trained AI/ML model parameters and determining, based on the re-trained AI/ML model parameters, the retrieval of the re-trained AI/ML model from the NRT-RIC framework;
request, by the rApp, the re-trained AI/ML model from the NRT-RIC framework; and
sending, by the NRT-RIC framework, the re-trained AI/ML model to the rApp.

3. The system as claimed in claim 1, wherein while re-training of at least one AI/ML model the at least one processor is further configured to:
re-train, by the rApp, an AI/ML model from the plurality of AI/ML models.

4. The system as claimed in claim 1, wherein the O1-related data providing O1 configurations required to perform the RF channel reconfiguration comprise at least one of configurations, performance indicators and measurement reports provided from the O-RU, wherein the measurement reports comprise at least one of an energy efficiency/energy consumption EE/EC measurement report, and
wherein the energy efficiency/energy consumption (EE/EC) measurement report comprises at least one of Reference Signal Received Quality (RSRQ) measurement per SSB per cell, energy consumption, power consumed by hardware component, transmit power, load statistics per cell and per carrier, such as number of active users, average number of Radio Resource Control (RRC) connections, average number of scheduled active users per Transmission Time Interval (TTI), Physical Resource Block (PRB) utilization, DownLink/UpLink (DL/UL) Cell/User throughput, Precoding Matrix Indicator/Channel State Information (PMI/CSI) reports, latency statistics per cell and power consumption metrics information on supported Tx/Rx array selections together with power consumption key performance indicators.

5. The system as claimed in claim 1, wherein comprises: wherein while collecting the O1-related data providing O1 configurations required to perform the RF channel reconfiguration, the at least one processor is configured to:
send, by the rApp, an O1-related data collection request via an R1 interface through the NRT-RIC framework and via an O1 interface through the SMO function within the SMO framework to the E2-node;
receive, by the E2 node, the O1-related data collection request from the SMO function and
collect, by the E2 node, the O1-related data providing O1 configurations required to perform the RF channel reconfiguration from the O-RU via an open front haul management plane FH M-Plane interface between the E2 node and the open radio unit O-RU; and
send, by the E2 node, the collected O1-related data providing O1 configurations required to perform the RF channel reconfiguration via the O1 interface through the SMO function and through the NRT-RIC framework within the SMO framework to the rApp via the R1 interface.

6. The system as claimed in claim 1, wherein the O1 configuration data to prepare and execute the RF channel reconfiguration comprise at least one of an O-RU Tx/Rx Array selection, a modification of the number of SU/MU MIMO spatial streams or data layers, a modification of the number of SSB beams and a modification of the O-RU antenna transmit power.

7. The system as claimed in claim 1, wherein the at least one processor is further configured to:
monitor, by the NRT-RIC, the performance of the re-trained AI/ML model;
determine that a predetermined performance objective is not achieved based on the collected O1-related data; and
initiate a fallback mechanism and/or initiating an AI/ML model update or retraining.

8. A method for implementing an optimization of an radio frequency (RF) reconfiguration within an open radio access network (O-RAN) by a service management and orchestration (SMO) framework, the method comprising:
collecting, by an rApp, O1-related data providing O1 configurations required to perform the RF channel reconfiguration via an R1 interface through an NRT-RIC framework and via an O1 interface through a SMO function within the SMO framework from an E2 node, wherein the O1-related data are collected via an open front haul management plane (FH M-Plane) interface between the E2 node and an open radio unit (O-RU);
based on the collected O1-related data, by the SMO, re-training of at least one artificial intelligence/machine learning (AI/ML) model and,
among the at least one re-trained AI/ML, deploying and activating, by the rApp, one re-trained AI/ML model for inferring data providing O1 configurations required to perform the RF channel reconfiguration within the O-RAN;
monitoring, by the rApp, via the R1 interface through the NRT-RIC framework and via an O1 interface through the SMO function within the SMO framework the O1-related data providing O1 configurations required to perform the RF channel reconfiguration;
evaluating, by the rApp, the O1-related data providing O1 configurations required to perform the RF channel reconfiguration;
determining, by the rApp, to generate O1 configuration data to prepare and execute the RF channel reconfiguration and
sending, by the rApp, via the R1 interface through the NRT-RIC framework and via the O1 interface through the at the least one SMO function within the SMO framework, the O1 configuration data to prepare and execute the RF channel reconfiguration to the least one E2 node;
implementing, by the E2 node and the O-RU, the RF channel reconfiguration within the O-RAN, wherein the implementing comprises:
converting, by the E2 node, the O1 configuration data to prepare and execute and instructing, by the E2 node, the O-RU to execute the RF channel reconfiguration via the open FH M-Plane.

9. The method as claimed in claim 8, wherein the re-training of at least one AIML model comprises:
selecting, by the rApp, an AI/ML model from a plurality of AI/ML models;
sending, by the rApp, an initiation request for re-training the AI/ML model to the NRT-RIC framework;
re-training the AI/ML model by the NRT-RIC framework;
monitoring, by the rApp, re-trained AI/ML model parameters and determining, based on the re-trained AI/ML model parameters, the retrieval of the re-trained AI/ML model from the NRT-RIC framework;
requesting, by the rApp, the re-trained AI/ML model from the NRT-RIC framework; and
sending, by the NRT-RIC framework, the re-trained AI/ML model to the rApp.

10. The method as claimed in claim 8, wherein the re-training of at least one AI/ML model comprises:
re-training, by the rApp, an AI/ML model from the plurality of AI/ML models.

11. The method as claimed in claim 8, wherein the O1-related data providing O1 configurations required to perform the RF channel reconfiguration comprise at least one of configurations, performance indicators and measurement reports provided from the O-RU, wherein the measurement reports comprise at least one of an energy efficiency/energy consumption EE/EC measurement report, and
wherein the energy efficiency/energy consumption (EE/EC) measurement report comprises at least one of Reference Signal Received Quality (RSRQ) measurement per Synchronization Signal Block (SSB) per cell, Reference Signals Received Power (RSRP) measurement per SSB per cell, Signal to Interference plus Noise Ratio (SINR) measurement per SSB per cell, energy consumption, power consumed by hardware component, transmit power, load statistics per cell and per carrier, such as number of active users, average number of Radio Resource Control (RRC) connections, average number of scheduled active users per Transmission Time Interval (TTI), Physical Resource Block (PRB) utilization, DownLink/UpLink (DL/UL) Cell/User throughput, Precoding Matrix Indicator/Channel State Information (PMI/CSI) reports, latency statistics per cell and power consumption metrics information on supported Tx/Rx array selections together with power consumption key performance indicators.

12. The method as claimed in claim 8, wherein collecting the O1-related data providing O1 configurations required to perform the RF channel reconfiguration comprises:
sending, by the rApp, an O1-related data collection request via an R1 interface through the NRT-RIC framework and via an O1 interface through the SMO function within the SMO framework to the E2-node;
receiving, by the E2 node, the O1-related data collection request from the SMO function and
collecting, by the E2 node, the O1-related data providing O1 configurations required to perform the RF channel reconfiguration from the O-RU via an open front haul management plane FH M-Plane interface between the E2 node and the open radio unit O-RU; and
sending, by the E2 node, the collected O1-related data providing O1 configurations required to perform the RF channel reconfiguration via the O1 interface through the SMO function and through the NRT-RIC framework within the SMO framework to the rApp via the R1 interface.

13. The method as claimed in claim 8, wherein the O1 configuration data to prepare and execute the RF channel reconfiguration comprise at least one of an O-RU Tx/Rx Array selection, a modification of the number of SU/MU MIMO spatial streams or data layers, a modification of the number of SSB beams and a modification of the O-RU antenna transmit power.

14. The method as claimed in claim 8, wherein the method further comprises:
monitoring, by the NRT-RIC, the performance of the re-trained AI/ML model;
determining that a predetermined performance objective is not achieved based on the collected O1-related data and initiating a fallback mechanism and/or initiating an AI/ML model update or retraining.

15. A non-transitory computer-readable recording medium having recorded thereon instructions executable by at least one processor configured to implement a non-real-time radio intelligent controller (NRT-RIC), an NRT-RIC framework, at least one SMO function and an rApp hosted by the NRT-RIC, to perform a method for implementing an optimization of an radio frequency (RF) reconfiguration within an open radio access network (O-RAN) by a service management and orchestration (SMO) framework, the method comprising:
collecting, by an rApp, O1-related data providing O1 configurations required to perform the RF channel reconfiguration via an R1 interface through an NRT-RIC framework and via an O1 interface through a SMO function within the SMO framework from an E2 node, wherein the O1-related data are collected via an open front haul management plane (FH M-Plane) interface between the E2 node and an open radio unit (O-RU);
based on the collected O1-related data, by the SMO, re-training of at least one artificial intelligence/machine learning (AI/ML) model and,
among the at least one re-trained AI/ML, deploying and activating, by the rApp, one re-trained AI/ML model for inferring data providing O1 configurations required to perform the RF channel reconfiguration within the O-RAN;
monitoring, by the rApp, via the R1 interface through the NRT-RIC framework and via an O1 interface through the SMO function within the SMO framework the O1-related data providing O1 configurations required to perform the RF channel reconfiguration;
evaluating, by the rApp, the O1-related data providing O1 configurations required to perform the RF channel reconfiguration;
determining, by the rApp, to generate O1 configuration data to prepare and execute the RF channel reconfiguration and
sending, by the rApp, via the R1 interface through the NRT-RIC framework and via the O1 interface through the at the least one SMO function within the SMO framework, the O1 configuration data to prepare and execute the RF channel reconfiguration to the least one E2 node;
implementing, by the E2 node and the O-RU, the RF channel reconfiguration within the O-RAN, wherein the implementing comprises:
converting, by the E2 node, the O1 configuration data to prepare and execute and
instructing, by the E2 node, the O-RU to execute the RF channel reconfiguration via the open FH M-Plane.

16. The non-transitory computer-readable recording medium as claimed in claim 15, wherein the re-training of at least one AI/ML model comprises:
selecting, by the rApp, an AI/ML model from a plurality of AI/ML models;
sending, by the rApp, an initiation request for re-training the AI/ML model to the NRT-RIC framework;
re-training the AI/ML model by the NRT-RIC framework;
monitoring, by the rApp, re-trained AI/ML model parameters and determining, based on the re-trained AI/ML model parameters, the retrieval of the re-trained AI/ML model from the NRT-RIC framework;
requesting, by the rApp, the re-trained AI/ML model from the NRT-RIC framework; and
sending, by the NRT-RIC framework, the re-trained AI/ML model to the rApp.

17. The non-transitory computer-readable recording medium as claimed in claim 15, wherein the re-training of at least one AI/ML model comprises:
re-training, by the rApp, an AI/ML model from the plurality of AI/ML models.

18. The non-transitory computer-readable recording medium as claimed in claim 15, wherein the O1-related data providing O1 configurations required to perform the RF channel reconfiguration comprise at least one of configurations, performance indicators and measurement reports provided from the O-RU, wherein the measurement reports comprise at least one of an energy efficiency/energy consumption EE/EC measurement report, and
wherein the energy efficiency/energy consumption (EE/EC) measurement report comprises at least one of Reference Signal Received Quality (RSRQ) measurement per SSB per cell, energy consumption, power consumed by hardware component, transmit power, load statistics per cell and per carrier, such as number of active users, average number of Radio Resource Control (RRC) connections, average number of scheduled active users per Transmission Time Interval (TTI), Physical Resource Block (PRB) utilization, DownLink/UpLink (DL/UL) Cell/User throughput, Precoding Matrix Indicator/Channel State Information (PMI/CSI) reports, latency statistics per cell and power consumption metrics information on supported Tx/Rx array selections together with power consumption key performance indicators.

19. The non-transitory computer-readable recording medium as claimed in claim 15, wherein collecting the O1-related data providing O1 configurations required to perform the RF channel reconfiguration comprises:
sending, by the rApp, an O1-related data collection request via an R1 interface through the NRT-RIC framework and via an O1 interface through the SMO function within the SMO framework to the E2-node;
receiving, by the E2 node, the O1-related data collection request from the SMO function and
collecting, by the E2 node, the O1-related data providing O1 configurations required to perform the RF channel reconfiguration from the O-RU via an open front haul management plane FH M-Plane interface between the E2 node and the open radio unit O-RU; and
sending, by the E2 node, the collected O1-related data providing O1 configurations required to perform the RF channel reconfiguration via the O1 interface through the SMO function and through the NRT-RIC framework within the SMO framework to the rApp via the R1 interface.

20. The non-transitory computer-readable recording medium as claimed in claim 15, wherein the O1 configuration data to prepare and execute the RF channel reconfiguration comprise at least one of an O-RU Tx/Rx Array selection, a modification of the number of SU/MU MIMO spatial streams or data layers, a modification of the number of SSB beams and a modification of the O-RU antenna transmit power.
